(19) United States
(12) Patent Application Publication
(10) Pub. No.: US 2018/0013700 A1
(43) Pub. Date: Jan. 11, 2018

(54) System for Inserting and Responding to Brand-Related Data in Communicated Messages

(71) Applicants: Jeffrey B. Berry, Barnhart, MO (US); Lee Alexander Lasch Holmes, Newnan, GA (US)

(72) Inventors: Jeffrey B. Berry, Barnhart, MO (US); Lee Alexander Lasch Holmes, Newnan, GA (US)

(21) Appl. No.: 15/703,851

(22) Filed: Sep. 13, 2017

Related U.S. Application Data
(63) Continuation of application No. 14/254,877, filed on Apr. 16, 2014.
Application No. 14/254,877 is a continuation of application No. 13/345,027, filed on Jan. 6, 2012, now abandoned.
Application No. 13/345,027 is a continuation of application No. 14/536,586, filed on Nov. 7, 2014.
Application No. 14/536,586 is a continuation-in-part of application No. 14/254,877, filed on Apr. 16, 2014.
(60) Provisional application No. 61/577,118, filed on Dec. 19, 2011.

(51) Int. Cl. H04L 12/58; G06Q 30/02; G06Q 10/10; G06Q 50/00

(52) U.S. Cl. CPC H04L 51/04; H04L 51/08; G06Q 10/10; G06Q 30/0241; G06Q 50/01

(57) ABSTRACT

A system for managing and processing of a user message as initiated by a sender messaging device of a sending user to an addressed receiver messaging device of a receiving user and transmitted through a telecommunication network to a multimedia messaging system (MMS) implemented therein for transmitting the received user message from the sender messaging device to the receiver messaging device based on an receiver message device address, a first server receives and manages brand-related data and configuration data for processing the messages and a second server creates a modified user message having the brand-related data (BRD) message inserted with the user message and within the messaging format of the user message and responsive to a BRD message insertion rule defined by the BRD configuration data associated with the BRD message, and then transmitting the modified user message to the addressed receiver messaging device.

### CROSS-REFERENCE TO RELATED APPLICATIONS

This application is a continuation of U.S. patent application Ser. No. 14/254,877, filed Apr. 16, 2014, which was a continuation of U.S. application Ser. No. 13/345,027, filed on Jan. 6, 2012, now abandoned, which claimed priority to U.S. Provisional Patent Application No. 61/577,118, filed on Dec. 19, 2011.

This application is also a continuation of U.S. patent application Ser. No. 14/536,586, filed on Nov. 7, 2014, which was a continuation-in-part application of U.S. application Ser. No. 14/254,877, filed on Apr. 16, 2014.

This application claims priority to each of the above U.S. applications, the disclosures of each application being incorporated herein by reference.

### FIELD

The present disclosure relates, generally, to the field of messaging and to, more particularly, the field of advertising via messaging.

### BACKGROUND

The statements in this section merely provide background information related to the present disclosure and may not constitute prior art.

For many years, sellers of products or services have used advertising to increase sales of their products or services by initially creating brand awareness amongst consumers and subsequently expanding on such brand awareness. The advertising has taken on many forms, with sellers constantly attempting to capitalize on new media. For example, when newspapers, magazines, and other forms of print media became widely distributed and read by consumers, sellers placed advertisements in newspapers and magazines that included the sellers' brands, logos, and/or slogans coupled with images and information about the sellers' products or services. When television sets were invented and became prevalent in consumers' homes, sellers created and continue to create, television commercials that were/are played frequently during breaks in programming. The commercials generally feature the sellers' brands, logos, and/or slogans as found in complementary print advertisements and video concerning the sellers' products or services, but also typically include music or jingles specifically produced for the commercials. Through the commercials' use of sight and sound, sellers have taken advantage of the audiovisual capabilities provided by television.

When Internet access became possible for consumers, sellers continued in their attempt to capitalize on new media via Internet advertisements that “pop up” or are otherwise displayed on the screens of consumers' computers, tablet devices, or smartphones. Such advertisements, similar to commercials, take advantage of the audiovisual capabilities provided by digital media through use of stationary or moving images coupled with music, jingles, or other sound. However, unlike commercials, such advertisements are adaptable at runtime, may collect inputs from consumers, and may link to the sellers' Internet websites so that sellers may present more thorough information about their products or services to consumers. Thus, by interacting with consumers and adapting to consumers' inputs, sellers have taken advantage of the additional capabilities provided by the Internet.

Despite sellers' attempts to continually capitalize on new media, sellers have seemingly been unable to capitalize, so far, on the tremendous growth of messaging services being offered by communications carriers and used by consumers to communicate textual and other messages with one another. Such messaging services are generally accessible via cell phones, smartphones, tablet devices, and other messaging-enabled devices and include, utilize or are based on, without limitation: Short Message Service (SMS) text messaging; Multimedia Messaging Service (MMS); iMessage®; Blackberry® Message; Samsung™ ChatOn; Instant Message; Twitter®; and Facebook®. Generally, messages communicated via such messaging services include only characters, numbers, or symbols of an alphanumeric character set that may be input to a messaging-enabled device through use of a physical or virtual keypad or keyboard.

There is, therefore, a need in the industry for systems, apparatuses and methods for inserting brands, logos, images, video, audio, hypertext links and other non-alphanumeric content into messages communicated via messaging services and that resolves these and other shortcomings, difficulties, or problems with present systems.

### SUMMARY

Briefly described, the present invention comprises a system, including apparatuses and methods, for inserting brand-related data into messages communicated via messaging services. According to example embodiments and without limitation, the brand-related data comprises or is representative of brands, logos, images, icons, graphic elements, symbols and links to Internet-accessible content, websites or webpages. The brand-related data is generally received from, or specified by, a system user including a seller or advertiser of products or services, but may be provided by another entity such as a communication carrier or an entity providing the functionality described herein. The brand-related data may be, based on received configuration input, inserted at random intervals/counts or pre-determined intervals/counts of messages or message bubbles. Also, the appearance and location of the brand-related data in messages displayed on a message receiving device of a message receiver may be configured. Additionally, the brand-related data may be configured to cause, upon selection (or clicking or tapping thereon) by a message receiver, various actions to be taken by the message receiving device, including, but not limited to: re-direction of the message receiving device to random, pre-determined or automated material, content, or an Internet webpage or website destination; initiating the execution of application software, and sharing or transferring images, video, and audio between a message sending device and the message receiving device. In addition, the display of brand-related data and taking of actions upon the selection thereof may be enabled or disabled based on the passage of a period of time or calendar date.

Advantageously, the system enables sellers and others to advertise and provide information about products and/or services by inserting brand-related data (including, but not limited to, logos, images, icons, graphic elements, symbols and/or hypertext links) into messages communicated via messaging systems. The system also enables sellers and others to conduct promotional campaigns through the insertion of brand-related data in messages associated with such campaigns that may be disabled after the passage of a period of time or a calendar date.

Other uses and benefits of the present invention may become apparent upon reading and understanding the present specification when taken in conjunction with the appended drawings.

Further aspects of the present disclosure will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1 displays a block diagram representation of a brand-related data insertion and response system in accordance with a first example embodiment of the present invention.

FIG. 2 displays a block diagram representation of the data configuration sub-system and system database of the brand-related data insertion and response system of FIG. 1 and an environment therefor via which brand-related data and associated configuration data are received from and managed by system users.

FIG. 3 displays a schematic representation of system data stored in the system database of the brand-related data insertion and response system of FIG. 1 for each system user.

FIG. 4 displays a block diagram representation of the data insertion sub-system, system database, and receiving device software of the brand-related data insertion and response system of FIG. 1 and an environment therefor via which brand-related data is inserted into messages communicated from a sending message device to a receiving device and via which the receiving device accesses resources linked to by hypertext links present in the brand-related data.

FIG. 5 displays a schematic representation of a message before insertion of brand-related data therein.

FIG. 6 displays a schematic representation of a message after insertion of brand-related data therein by the data insertion sub-system of the brand-related data insertion and response system of FIG. 1.

FIGS. 7A and 7B display a flowchart representation of a method of the brand-related data insertion and response system of FIG. 1 for receiving and storing brand-related data and associated configuration data.

FIGS. 8A and 8B display a flowchart representation of a method of the brand-related data insertion and response system of FIG. 1 for inserting brand-related data into messages.

FIGS. 9A-9C display a flowchart representation of a method of the brand-related data ion and response system of FIG. 1 for receiving and displaying messages including brand-related data and for taking further action based on selection of the brand-related data.

FIG. 10 displays a pictorial representation of a message receiving device displaying messages into which brand-related data has been inserted by the data insertion sub-system of the brand-related data insertion and response system of FIG. 1.

FIG. 11 displays a block diagram representation of a brand-related data insertion and response system in accordance with a second example embodiment of the present invention.

FIG. 12 displays a block diagram representation of the request generation software, message generation sub-system, and receiving device software of the brand-related data insertion and response system of FIG. 11 and an environment therefor via which message generation including brand-related data therein is initiated by a message initiation and management system of a system user. according to

[symbol]

It should be understood that throughout the drawings, corresponding reference numerals indicate like or corresponding parts and features.

### DETAILED DESCRIPTION

The following description is merely exemplary in nature and is not intended to limit the present disclosure or the disclosure's applications or uses.

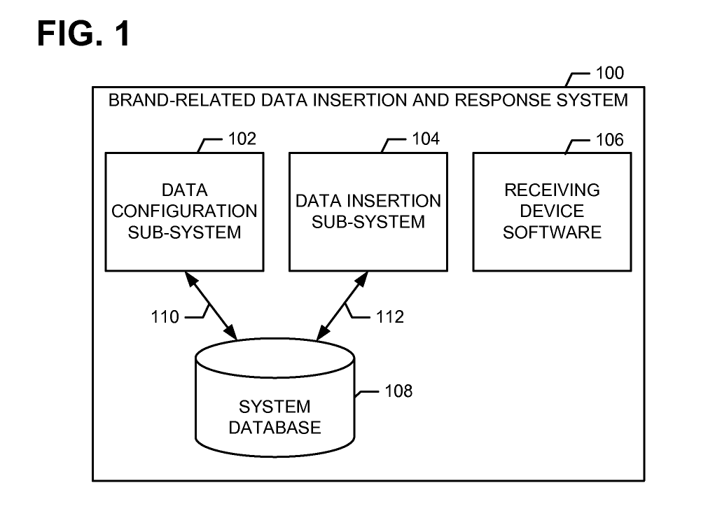

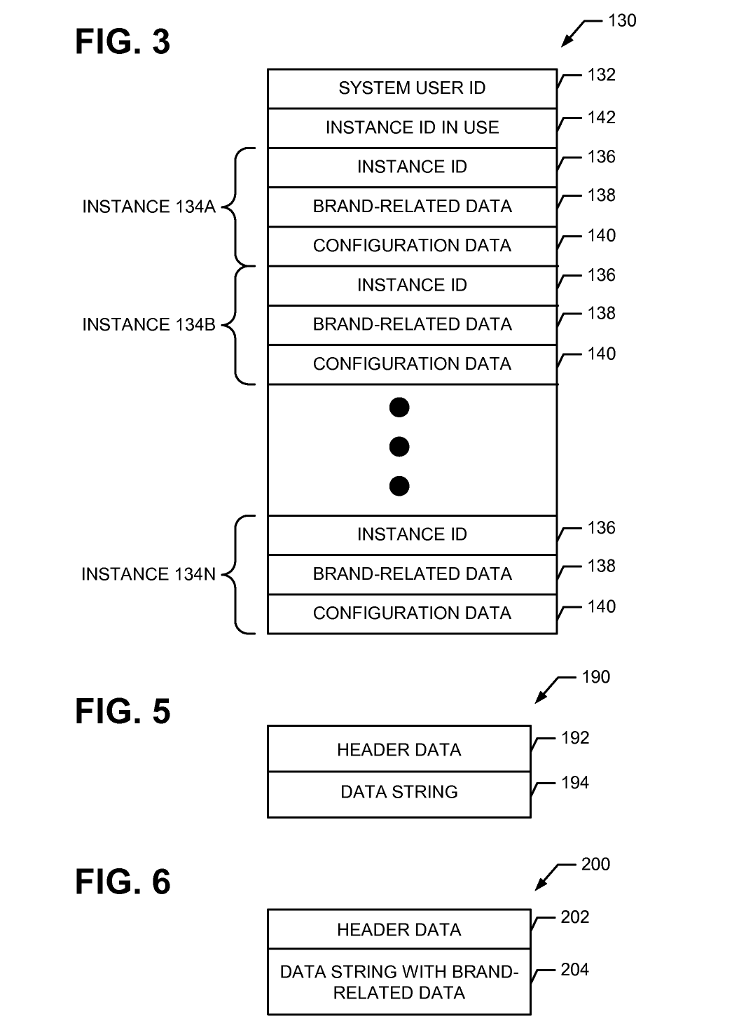

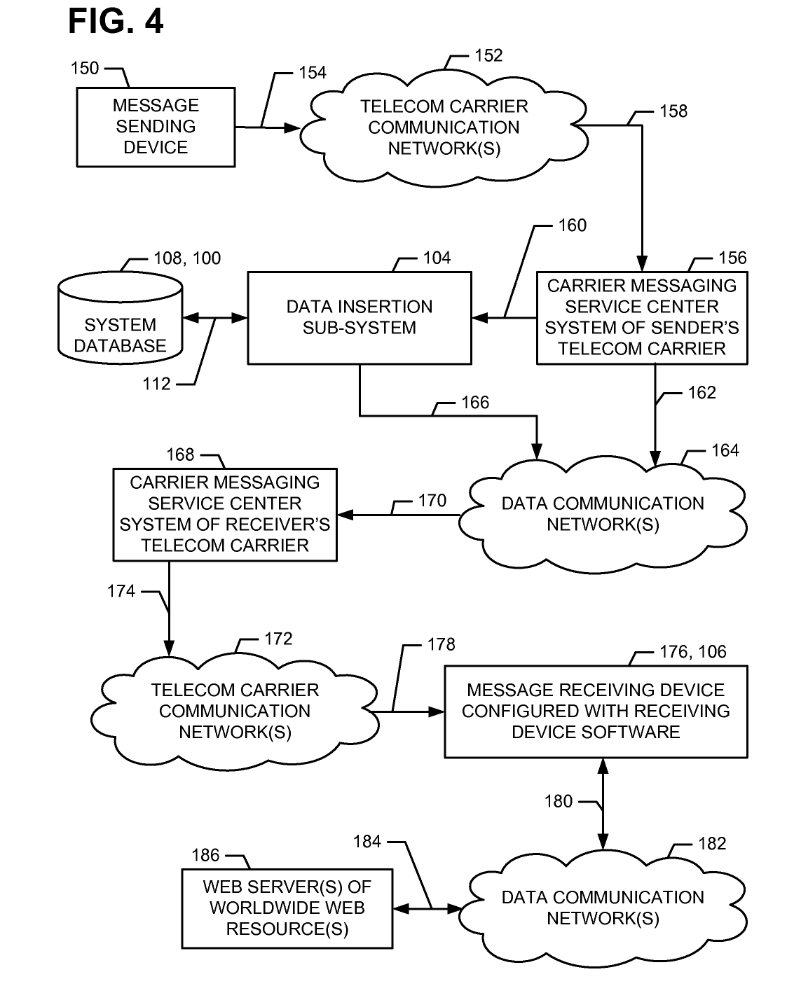

Referring now to the drawings in which like numerals represent like elements or steps throughout the several views and in accordance with a first example embodiment, FIG. 1 displays a brand-related data insertion and response system 100 (also sometimes referred to herein as the “system 100”) for inserting and responding to the subsequent selection of brand-related data 138 (see FIG. 3) in messages generated by message sending devices 150 (see FIG. 4) of message senders and communicated to message receiving devices 176 used by message receivers. The system 100 receives messages during their communication between the message sending devices 150 and the message receiving devices 176 and inserts previously received brand-related data 138 in accordance with previously received configuration data 140 associated with the brand-related data 138. As used herein, the term “message” comprises, without limitation, a brief electronic message communicated via the Short Message Service (SMS) text messaging; Multimedia Messaging Service (MMS); iMessage®; Blackberry® Message; Samsung™ ChatOn; Instant Message; Twitter®; and Facebook®, or other similar messaging service or technology existing now or in the future. The term “brand-related data 138” comprises, without limitation, data representative of or corresponding to an image, picture, symbol, icon or graphic element used as a brand, trademark, or service mark associated with a company, business, organization, product, or service. The term “brand-related data 138” may further optionally comprise, but not be limited to, a hypertext link, Worldwide Web link, or other link to an image, video, audio, document, material, program, webpage, website, or other resource accessible via the Worldwide Web and Internet, that is inserted into a message by the system 100 for subsequent selection by a message receiver.

Upon receiving a message including brand-related data 138, the message receiving device 176 of the message receiver displays the inserted image, picture or graphic element of the brand-related data 138 together with the accompanying text of the message, thereby enabling the owner or licensee of the brand, trademark or service mark to get the brand, trademark, or service mark before the message receiver and increasing the message receiver's brand awareness. If a hypertext link or other link has been inserted with and accompanies the image, picture or graphic element of the brand-related data 138, the system 100 detects selection of the image, picture or graphic and uses the embedded hypertext link or other link to redirect the message receiving device 176 to access and display or playback images, videos, audios, information, documents, materials, programs, webpages, websites, or other resources, as appropriate. By linking to a Worldwide Web resource when the image, picture or graphic is selected by the message receiver from his/her message receiving device 176, the system 100 allows the owner or licensee to provide the message receiver with further information about the owner or licensee's products or services via other images, videos, audios, documents, materials, programs, webpages, websites or other resources, and thereby further increase the message receiver's brand awareness. The system 100 may be employed directly by the owners or licensees of brands, trademarks or service marks, or may be employed indirectly on behalf of the owners or licensees of brands, trademarks or service marks by advertising agencies and other similar parties, to readily create a large number of brand impressions in a short period of time for the owners or licensees of brands, trademarks, or service marks.

The brand-related data insertion and response system 100 includes a data configuration sub-system for managing brand-related data 102, data insertion sub-system 104, receiving device software 106, and a system database 108. The data configuration sub-system for managing embedded message data 102 (also sometimes referred to herein as “data configuration sub-system 102”) includes computer and telecommunications hardware/software adapted for receiving and managing brand-related data 138 (see FIG. 3) that is to be subsequently inserted by the system 100 into messages being communicated between message sending devices 150 and message receiving devices 176. The data configuration sub-system 102 is adapted to store in and retrieve from the system database 108 via communication link 110, brand-related data 138 and configuration data 140 uniquely associated with such brand-related data 138. In accordance with the example embodiment, the data configuration sub-system 102 may be implemented via and include a combination of a web server, applications server, database management software, and other software residing on and executed by one or more server computer systems that may be physically located in the same or different facilities.

The system database 108 stores brand-related data 138 and associated configuration data 140 that may, without limitation, define when, how often, and/or the circumstances under which the corresponding brand-related data 138 is inserted into messages, identify the location within the messages at which the corresponding brand-related data 138 is inserted, provide a hypertext link or other link to and enabling the access of a resource (such as, but not limited to, an image, video, audio, document, material, program, webpage, or website) accessible via the Worldwide Web or Internet, include timer data indicating how long brand-related data 138 is to be displayed or usable or indicating when brand-related data 138 is to become displayed or usable, and define one or more action(s) to be taken in response to selection of the corresponding brand-related data 138 by a message receiver at a message receiving device 176. For example and not limitation, the configuration data 140 may require that its associated brand-related data 138 be inserted by the data insertion sub-system 104 into every message received by the system 100 or that a certain number of received messages be skipped before inserting the brand-related data 138 into a received message. In another example and absent limitation, the configuration data 140 may require that the data insertion sub-system 104 insert the associated brand-related data 138 at the beginning or end of a received message. In still another example and without limitation, the configuration data 140 may include a hypertext link or other link to a resource accessible via the Worldwide Web or Internet that is to be inserted by the data insertion sub-system 104 into a received message in addition to the brand-related data 138. The system database 108 may be physically located at the same location as the data configuration sub-system 102 or data insertion sub-system 104, or at another location, and be communicatively connected to the data configuration sub-system 102 and data insertion sub-system 104 for the bi-directional communication of data therewith. The system database 108 may comprise one or more storage devices, database management software, and one or more server computers and appropriate telecommunications hardware/software to provide the functionality described herein.

The data insertion sub-system 104 is configured to retrieve brand-related data 138 and associated configuration data 140 from the system database 108 via communication link 112, to receive messages being communicated from a message sending device 150 to a message receiving device 176, and to insert the brand-related data 138 and timer data, if any, into received messages in accordance with the configuration data 140 associated with the brand-related data 138. According to the first example embodiment, the data insertion sub-system 104 comprises one or more server computer systems configured with insertion software executed by the server computer systems and configured with telecommunications interface hardware/software for receiving and sending messages, all of which being appropriate to provide the functionality described herein. The data insertion sub-system 104 is communicatively connected to a carrier messaging service center system 156 for the message sender's telecommunications carrier (see FIG. 4). The data insertion sub-system 104 may physically reside in the same facility as the carrier's messaging service center system 156 or in another facility with the data insertion sub-system 104 being communicatively connected to the carrier messaging service center system 156.

The receiving device software 106 resides on a message receiving device 176 and is executed by a processing unit thereof. The receiving device software 106 is adapted to receive a message including brand-related data 138 and, possibly, timer data, to decipher the brand-related data 138 and timer data, and to take action based on the particular brand-related data 138 and timer data present. For example, if the brand-related data 138 comprises an image, the receiving device software 106 causes the message receiving device 176 to display the image (which may comprise a system user's logo) together with the text of the message on the display of the message receiving device 176. In another example, if the brand-related data 138 comprises a hypertext link to a resource accessible via the Worldwide Web and Internet, the receiving device software 106 uses the hypertext link to access the resource. If, for instance, the resource is a video or audio, the receiving device software 106 uses the link to cause the message receiving device 176 to download the video or audio to the message receiving device 176 and play it back to the message receiver. If, in another instance, the resource is a website or a webpage, the receiving device software 106 causes the message receiving device 176 to initiate operation of a web browser thereon and uses the link to cause connection to and display of the website or webpage. If, in still another instance, the resource is a document, the receiving device software 106 causes the message receiving device 176 to initiate operation of a document viewer thereon and uses the link to cause the message receiving device 176 to download and display the document via the document viewer. The actions taken by the receiving device software 106 are also based, in part, on the presence of timer data, which as described in more detail below, may allow actions to be taken for a pre-determined period of time or until a pre-identified calendar data, or actions not to be taken until after the passage of a pre-determined period of time or a pre-identified calendar date. According to the first example embodiment, the receiving device software 106 comprises an application programming interface (“API”) that is operable with the message receiving device's messaging software. However, in other example embodiments, the receiving device software 106 may comprise another form of programming executable by the message receiving device 176 or be included in the message receiving device's messaging software to provide the functionality described herein.

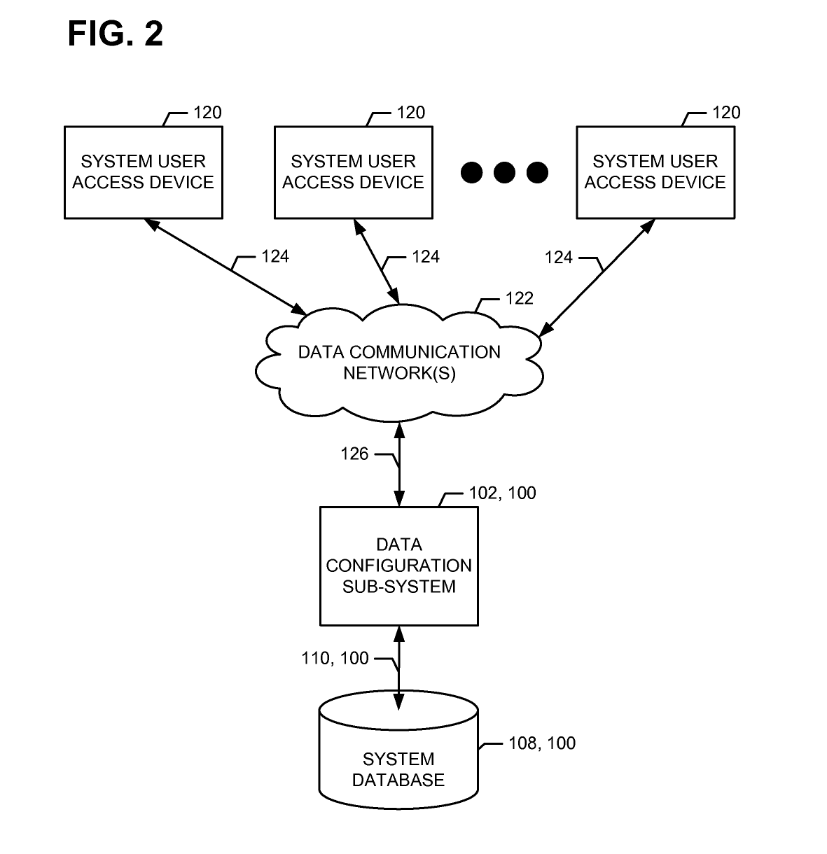

FIG. 2 displays a block diagram representation of the data configuration sub-system 102 and system database 108 of the brand-related data insertion and response system 100 and an environment therefor via which brand-related data 138 and associated configuration data 140 are received from and managed by system users. As illustrated in FIG. 2, the data configuration sub-system 102 is communicatively connected to one or more system user access devices 120 via one or more data communication network(s) 122 and bi-directional communication links 124. The term “system user” comprises a business, company, entity, organization, group, or person that desires to have brand-related data 138 inserted into communicated messages. System users often include, without limitation, manufacturers and sellers of products or services, advertisers, advertising agencies, and telecommunication carriers. The system user access devices 120 include, but are not limited to, computer, tablet, smartphone, and other similar devices of system users that are configured for: bi-directionally communicating data with the data configuration sub-system 102; displaying a data configuration/management graphical user interface of the data configuration sub-system 102, brand-related data 138, and associated configuration data 140; receiving input from a system user comprising identifying, uploading, downloading, editing, or deleting brand-related data 138 and associated configuration data 140; and, directing the data configuration sub-system 102 to retrieve or store brand-related data 138 and associated configuration data 140. The data communication network(s) 122 and bi-directional communication links 124 comprise wired and wireless communications infrastructure adapted for communicating data via wired and wireless methods and include, without limitation, the communications infrastructure commonly referred to as the Internet.

FIG. 3 displays a schematic representation of system data 130 stored in the system database 108 for each system user in accordance with the first example embodiment. The system data 130 comprises a system user identifier 132 that uniquely identifies each system user from every other system user of the brand-related data insertion and response system 100, and serves to distinguish the brand-related data 138 and associated configuration data 140 for the corresponding system user from that stored for other system users. The system user identifier 132 is automatically assigned by the system 100 to the system user or is manually assigned by a system administrator to the system user, when the system user becomes a user of the system 100.

The system data 130 further comprises one or more instances 134 of brand-related data 138 and associated configuration data 140 that have been received from, or on behalf of, the system user via the operation of and interaction with the data configuration sub-system 102. Each instance 134 of brand-related data 138 and associated configuration data 140 is available to the data insertion sub-system 104 for use in inserting the brand-related data 138 thereof into messages received by the system 100, and is assigned a unique instance ID 136 by the data configuration sub-system 102 when received from a system user. During operation of the system 100, the data configuration sub-system 102 receives input from the system user or a system administrator selecting and identifying a particular instance 134 that is to be used by the data insertion sub-system 104 for inserting brand-related data 138 thereof into messages. The instance ID 136 of the selected and identified instance 134 is stored by the data configuration sub-system 102 in the system data 130 as the instance ID in use 142. By enabling a system user to select and identify different instances 134 of brand-related data 138 for insertion into messages, the system user may use the system 100 in connection with different advertising or promotional campaigns by instructing the system 100 to use different instances 134 during different days and for different periods of time.

FIG. 4 displays a block diagram representation of the data insertion sub-system 104, system database 108, and the receiving device software 106 in an environment therefor in which brand-related data 138 is inserted into a message being communicated from a message sending device 150 to a message receiving device 176 and is acted upon to access a Worldwide Web resource. As shown in FIG. 4, the message sending device 150 of a message sender is connected to telecom carrier communication network 152 via a communication link 154. The message sender generally receives telecommunications services, including messaging services, on a subscription basis from a telecommunications carrier that provides and operates telecom carrier communication network 152. The message sending device 150 comprises any device possessed or used by the message sender that is configured to receive input of a message from the message sender and to send the message to the message receiving device 176, initially by sending the message to the telecom carrier communication network 152 via communication link 154. According to the first example embodiment, the message sending device 150 comprises a smartphone capable of sending and receiving messages, but may comprise cell phones, computers, tablet devices, or other devices in other example embodiments.

The message sender's telecommunications carrier also, typically, provides and operates a carrier messaging service center system 156 that is communicatively connected to the telecom carrier communication network 152 by communication link 158. The carrier messaging service center system 156 is, in turn, communicatively connected to the data insertion sub-system 104 by communication link 160 and to one or more data communication network(s) 162 by communication link 164. The carrier messaging service center system 156 is configured to receive a message via communication link 158 during operation, to determine whether the message sender has pre-authorized insertion of brand-related data 138 into his/her messages, to forward the message to the data insertion sub-system 104 via communication link 160 if the insertion of brand-related data 138 has been pre-authorized, and to forward the message to the data communication network(s) 162 via communication link 164 if the insertion of brand-related data 138 has not been pre-authorized by the message sender.

The data insertion sub-system 104 receives a message forwarded via communication link 160 and retrieves, via communication link 112, the brand-related data 138 and configuration data 140 for the instance 134 of the system user then identified in the system database 108 as the instance ID in use 142. Based on the configuration data 140 and the frequency of insertion specified therein, the data insertion sub-system 104 either inserts the brand-related data 138 into the received message according to other parameters of the configuration data 140 or skips insertion of the brand-related data 138. The message, with or without inserted brand-related data 138, is communicated from the data insertion sub-system 104 to the data communication network(s) 164 via communication link 166.

Carrier messaging service center system 168 is provided and operated by the telecommunications carrier from which the message receiver receives telecommunications services, including messaging services, on a subscription basis. The carrier messaging service center system 168 is communicatively connected to the data communication network(s) 164 by communication link 174. The message receiver's telecommunications carrier also, typically, provides a telecom carrier communication network 172 that is communicatively connected by communication link 174 to carrier messaging service center system 168. Telecom carrier communication network 172 is communicatively connected to the message receiving device 176 of the message receiver via communication link 178. The message receiving device 176 comprises any device possessed or used by the message receiver that is configured to receive a message from the message sending device 150 and to present the message to the message receiver. The message receiving device 176 is also configured with the receiving device software 106, which takes actions (as described herein) based on the brand-related data 138 present in the message. According to the first example embodiment, the message receiving device 176 comprises a smartphone capable of sending and receiving messages, but may comprise cell phones, computers, tablet devices, or other devices in other example embodiments.

The message receiving device 176 is communicatively connected by communication link 180 to one or more data communication networks 182. Via the data communication networks 182 and a communication link 184, one or more web server systems 154 are communicatively connected to the data communication networks 182 and permit accessing of or interaction with Worldwide Web resources by the message receiving device 176, as appropriate, based on the brand-related data 138 present in the message.

When the brand-related data insertion and response system 100 has been implemented as illustrated in FIG. 4 and a message 190 (see FIG. 5) is sent by a message sender through use of a message sender device 150, the message 190 is communicated to the carrier messaging service center system 156 of the message sender's telecommunications carrier through the telecom carrier communication network 152 and communication links 154, 158. As described above, the carrier messaging service center system 156 forwards the message 190 to the data insertion sub-system 104 via communication link 16 if the message sender has pre-authorized the insertion of brand-related data into his/her messages. As also described above and based on the configuration data 140 associated with the brand-related data 138, the data insertion sub-system 104 either inserts the brand-related data 138 into the message to produce a message 200 having brand-related data inserted therein or forwards the message 190 without inserting the brand-related data 138 therein.

Message 190 or message 200, whichever the case, is communicated by the data insertion sub-system 104 to the message receiving device 176 via the data communication network(s) 164, the carrier messaging service center system 168, the telecom carrier communication network(s) 172, and communication paths 166, 170, 174, 178. If the message 190 has no brand-related data 138, the message receiving device 176 presents the message 190 to the message receiver as a conventional message. However, if the message 190 has brand-related data 138, the receiving device software 106 causes the message receiving device 176 to take action based on the brand-related data 138. As described above, the action may involve displaying an image (such as, but not limited to, a logo) on the display of the message receiving device 176. The action may also involve using a link in the brand-related data 138 to access Worldwide Web resources via data communication network(s) 182 and communication paths 180, 184 and to present them to the message receiver. Other actions, as noted above, may be performed depending on the content of the particular brand-related data 138.

FIG. 5 displays a schematic representation of the data of a message 190 generated by the message sending device 150 and that does not include brand-related data 138. Message 190 corresponds to a conventional message used in a respective messaging system and generally includes messaging system data used for delivery and handling of the message 190 by the messaging system and content data corresponding to content being conveyed by the message sender to the message receiver. According to the first example embodiment, the message 190 comprises a Short Message Service (SMS) message including header data 192 corresponding to messaging system data and a data string 194 corresponding to the content of the message 190. The header data 192 may comprise a variety of data elements including, but not limited to, data corresponding to the telephone number of the message receiving device 176 to which the message 190 is to be delivered. The data string 194 comprises may include a plurality of alphanumeric characters.

FIG. 6 displays a schematic representation of the data of a message 200 having brand-related data 138 inserted therein by the data insertion sub-system 104. Similar to message 190, the message 200 includes messaging system data used for delivery and handling of the message 200 by the messaging system and content data corresponding to content being conveyed by the message sender to the message receiver. According to the first example embodiment, the message 200 comprises a Short Message Service (SMS) message including header data 202 and a data string 204. The header data 202 is substantially similar to the header data 192 of message 190. However, the data string 204 comprises message content in the form of a plurality of alphanumeric characters and brand-related data 138 that is inserted into the message 200 by the data insertion sub-system 104. As described herein, the brand-related data 138 comprises data representative of or corresponding to an image (such as, but not limited to, a brand, logo, picture, or graphic element), video, audio, or link, hyperlink, or Worldwide Web link to a resource (such as, but not limited to, an image, video, audio, document, material, program, webpage, or website) accessible via the Worldwide Web and the Internet.

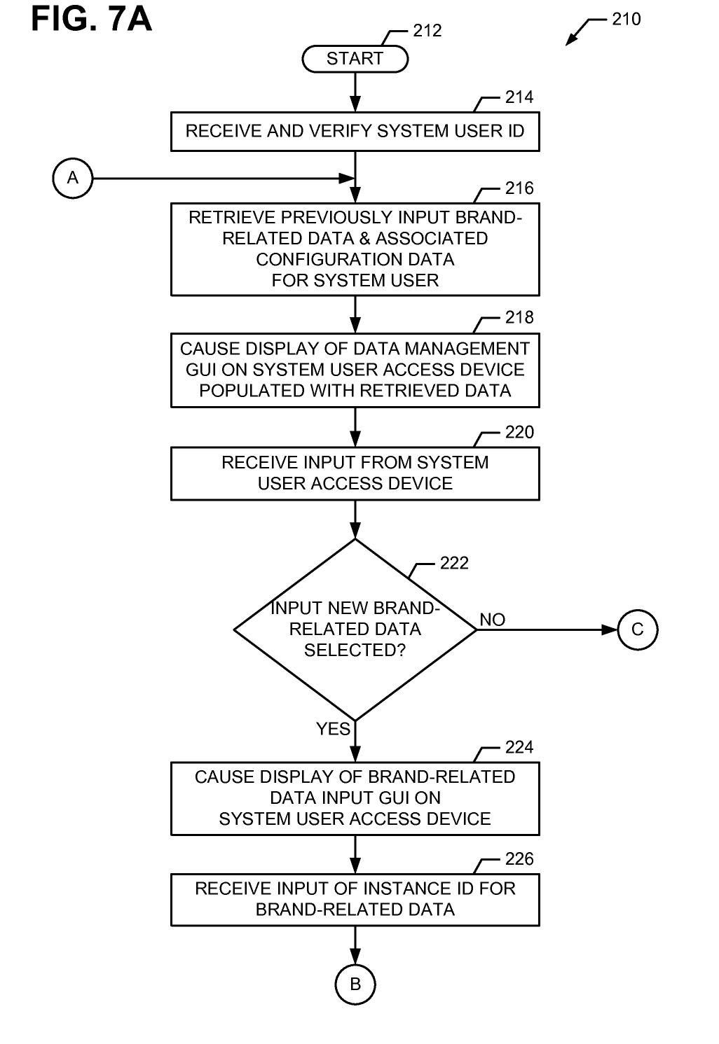

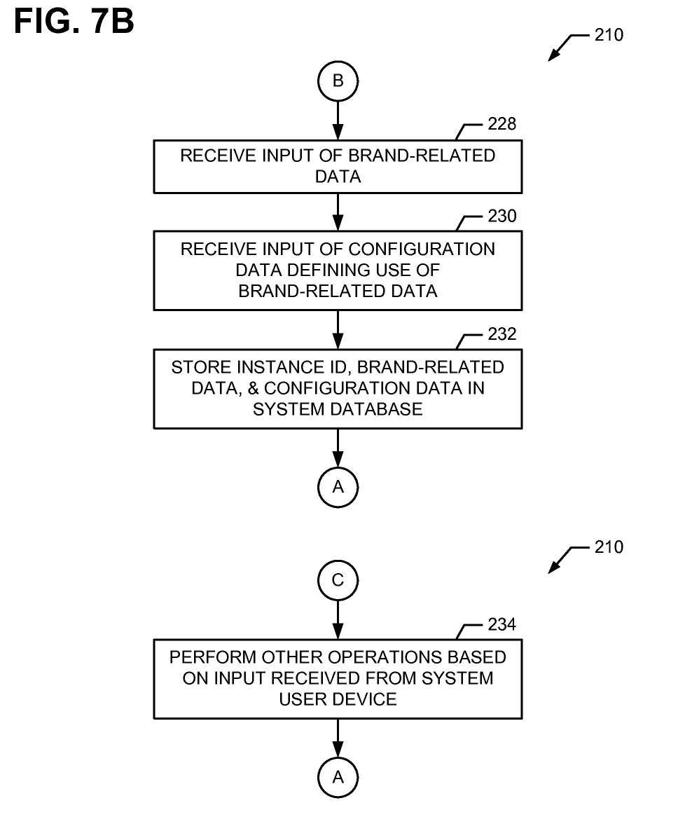

FIGS. 7A and 7B display a flowchart representation of a method 210 of the brand-related data insertion and response system 100 for receiving and storing brand-related data 138 and associated configuration data 140 for subsequent insertion into messages 190 being communicated from a message sending device 150 to a message receiving device 176. The method 210 is implemented, at least in part, by operation of the data configuration sub-system 102 and system database 108. The data configuration sub-system 102 is accessed by system users invoking operation of Internet browser software on system user access devices 120 used, respectively, by the system users to initiate a communication session with the data configuration sub-system 102 via data communication network(s) 122 and communication links 124, 126. In response, the data configuration sub-system 102 interacts with the browser software via the communication of hypertext markup language (HTML) to the system user access devices 120 and the receipt of input from the system user access devices 120.

After initiation of a communication session by a system user access device 120, operation according to method 210 starts at step 212 and advances to step 214 where the data configuration sub-system 102 system receives input of a system user identifier 132 from the system user access device 120 of the system user. The data configuration sub-system 102 verifies that the system user identifier 132 corresponds to and identifies a valid system user. Then, at step 216, the data configuration sub-system 102 uses the input system user identifier 132 to retrieve previously input brand-related data 138 and associated configuration data 140, if any, from the system database 108 for the system user. Next, at step 218, the data configuration sub-system 102 causes the display of a data management graphical user interface on a display of the system user access device 120 that is populated with the retrieved brand-related data 138 and associated configuration data 140.

At step 220, the data configuration sub-system 102 receives further input from the system user access device 120 via the data communication network(s) 122 and communication links 124, 126. Typically, the input corresponds to the selection of a user interface control of the data management graphical user interface whose selection causes the data configuration sub-system 102 to take desired action. If, at step 222, the data configuration sub-system 102 determines that the received input corresponds to the selection of a user interface control indicating that the system user desires to input new brand-related data 138, method 210 advances to step 224 where the data configuration sub-system 102 causes display of a brand-related data input graphical user interface on the system user access device 120 of the system user. Then, at step 226, the data configuration sub-system 102 receives input of an instance identifier 136 from the system user access device 120 for use in identifying and uniquely distinguishing the new brand-related data 138 to be input by the system user from any previously input brand-related data 138 of the system user. Subsequently, at steps 228 and 230, the data configuration sub-system 102 receives the input of new brand-related data 138 and associated configuration data 140 defining use of the brand-related data 138. After receiving the new brand-related data 138 and associated configuration data 140 for a new instance 134, the data configuration sub-system 102 stores the received instance identifier 136, brand-related data 138, and associated configuration data 140 in the system database 108 at step 232 of method 210 before looping back to step 216 described above.

Referring back to step 222 of method 210, if the data configuration sub-system 102 determines that the received input does not correspond to the selection of a user interface control indicating that the system user desires to input new brand-related data 138, operation according to method 210 advances to step 234 where the data configuration sub-system 102 performs other functions in accordance with the received input. For example and not limitation, such other functions may include editing or deleting an instance 134 of previously input brand-related data 138 and associated configuration data 140, or selecting an instance 134 (and corresponding instance identifier 136) of brand-related data 138 as the instance identifier in use 142 by the data insertion sub-system 104. After performing such other functions, operation according to method 210 returns to step 216 described above.

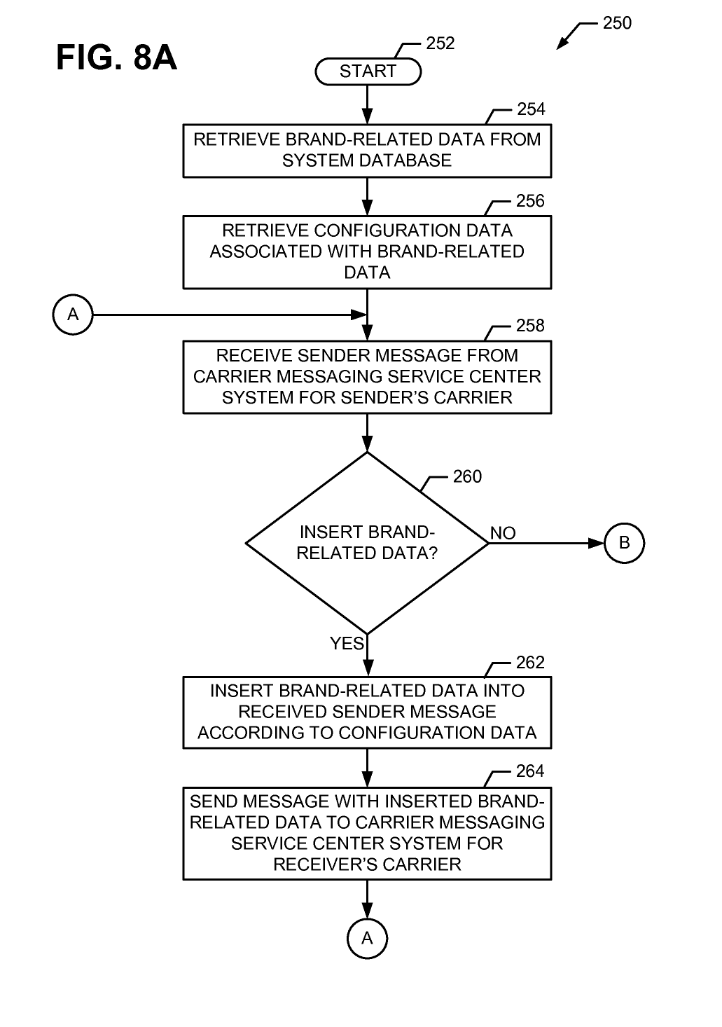

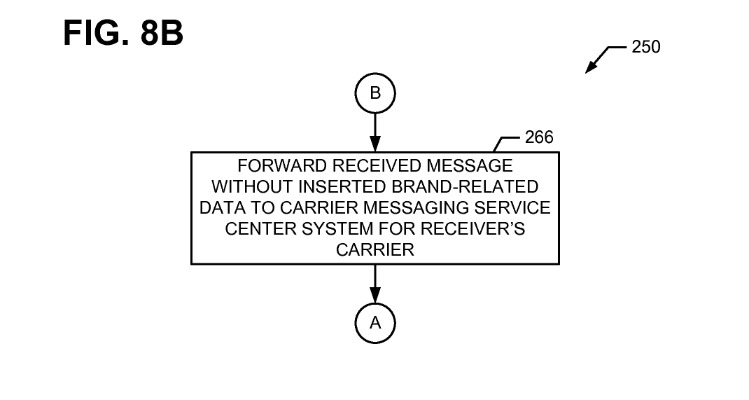

FIGS. 8A and 8B display a flowchart representation of a method 250 of the brand-related data insertion and response system 100 for inserting brand-related data 138 into messages 190 generated by message sending devices 150 of message senders in accordance with the first example embodiment. The method 250 is implemented, at least in part, by operation of the data insertion sub-system 104 and system database 108. The data insertion sub-system 104, including the one or more server computer systems and insertion software thereof, operate continuously after being started to receive messages 190 generated by the message sending devices 150 of message senders and to insert brand-related data 138 therein according to associated configuration data 140 to produce messages 200 including a data string 194 having brand-related data 138 therein.

After operation according to method 250 starts at step 252, the data insertion sub-system 104 retrieves brand-related data 138 from the system database 108 using the instance identifier in use 142 for each system user at step 254. As described above, the instance identifier in use 142 identifies the particular instance 134 for each system user that is to be used by the data insertion sub-system 104 for inserting brand-related data 138 into received messages 190. If no instance identifier in use 142 exists for a particular system user, then no brand-related data 138 of that system user will be inserted into received messages 190. Next, at step 256, the data insertion sub-system 104 retrieves the configuration data 140 associated with the brand-related data 138 retrieved at step 254.

At step 258, the data insertion sub-system 104 receives a message 190 generated by a message sending device 150 and forwarded to the data insertion sub-system 104 by the carrier messaging service center 156 of the message sender's telecommunications carrier. Generally, the carrier messaging service center 156 only forwards messages 190 from those message senders who have pre-authorized the insertion of brand-related data 138 in their messages 190. To determine if the message 190 should be forwarded, the carrier messaging service center 156 checks the message sender information present in the header data 192 of each received message 190 against previously received data from message senders that either pre-authorizes the insertion of brand-related data 138 or not. In an another embodiment, all messages 190 may be forwarded to the data insertion sub-system 104 with the determination of whether the insertion of brand-related data 138 has been pre-authorized by the message sender being handled by the data insertion sub-system 104.

Upon receiving a message 190 and in accordance with the first example embodiment, the data insertion sub-system 104 decides whether brand-related data 138 should be inserted into the received message 190. To do so, the data insertion sub-system 104 uses the retrieved configuration data 140 associated with the retrieved brand-related data 138 and may consider a variety of information and factors, alone or in combination. For example, the retrieved configuration data 140 may instruct the data insertion sub-system 104 to insert brand-related data 138 into every third received message 190, but in no others. Coupled with information maintained by the data insertion sub-system 104 representing a count of the number of received messages 190 since brand-related data 138 was last inserted into a received message 190, the data insertion sub-system 104 decides whether to insert brand-related data 138 into the currently received message 190. In another example, the retrieved configuration data 140 may instruct the data insertion sub-system 104 to insert brand-related data 138 into every received message 190. In such case, the data insertion sub-system 104 decides to insert the brand-related data 138 into each received message 190, including the currently received message 190. In still another example, the retrieved configuration data 140 may instruct the data insertion sub-system 104 to skip the insertion of brand-related data 138 into a message 190 that is part of a group of messages 190 corresponding to a dialog between a message sender and a message receiver if brand-related data 138 has already been inserted into one or more of the messages 190 of the group of messages 190. In such case, the data insertion sub-system 104 checks or tracks the number of times that brand-related data 138 has been inserted into messages 190 comprising the group of messages 190 and decides whether to insert brand-related data 138 into the currently received message 190 based on the configuration data 140 together with the number of times that brand-related data 138 has already been inserted.

If, at step 260, the data insertion sub-system 104 decides that brand-related data 138 should be inserted into the currently received message 190, operation according to method 250 advances to step 262 where the data insertion sub-system 104 inserts the brand-related data 138 into the received message 190 in accordance with the configuration data 140 associated with the brand-related data 138 to produce a corresponding message 200 having a data string 204 with the brand-related data 138 embedded therein. For example, if the brand-related data 138 corresponds to a logo and if the configuration data 140 instructs the data insertion sub-system 104 to insert only the logo, the data insertion sub-system 104 inserts the logo into the received message 190. In another example, if the brand-related data 138 corresponds to a logo coupled with a hypertext link to a Worldwide Web resource accessible via the Internet and if the configuration data 140 instructs the data insertion sub-system 104 to insert both, the data insertion sub-system 104 inserts the logo and hypertext link into the message 190. In still another example, if the brand-related data 138 corresponds to a logo and/or hypertext link to a Worldwide Web resource accessible via the Internet and if the configuration data 140 instructs the data insertion sub-system 104 to insert the logo and/or hypertext link coupled with timer data indicating a period of time during which the logo is to be displayed on the display of a message receiving device 176 when the produced message 200 is viewed by the message receiver, the data insertion sub-system 104 inserts the logo and/or hypertext link together with the timer data into the received message 190 to generate message 200. In such case, once the period of time has passed, the logo will no longer be displayed on the display of the message receiving device 176. In yet another example, if the brand-related data 138 corresponds to a logo and/or hypertext link to a Worldwide Web resource accessible via the Internet and if the configuration data 140 instructs the data insertion sub-system 104 to insert the logo and/or hypertext link coupled with timer data indicating a calendar date prior to which the logo is to be displayed on the display of a message receiving device 176 when the produced message 200 is viewed by the message receiver, the data insertion sub-system 104 inserts the logo and/or hypertext link together with the timer data into the received message 190 to generate message 200. In such case, once the calendar date has passed, the logo will no longer be displayed on the display of the message receiving device 176. As an alternative to the prior examples involving the insertion of timer data, once the period of time or calendar date has passed, the logo may still be displayed, but use and operation of the hypertext link may be disabled. In another alternative, the timer data may correspond to a period of time or calendar date which after passage causes a logo to be become displayed thereafter and/or causes use and operation of a hypertext link to be enabled.

Continuing operation according to method 250 at step 264, the data insertion sub-system 104 sends message 200 including the inserted brand-related data 138 and, possibly, timer data or other data embedded in the data string 24 thereof to the carrier messaging service center 168 of the message receiver's telecommunications carrier via data communication network(s) 164 and communication links 166, 178. Subsequently, the carrier messaging service center 168 delivers the message 200 to the message receiving device 176 of the message receiver via telecommunication carrier communication network(s) 172 and communication links 174, 178. After sending message 200, operation of method 250 loops back to step 258 described above.

Returning to step 260, if the data insertion sub-system 104 decides that brand-related data 138 should not be inserted into the currently received message 190, operation according to method 250 branches to step 266 where the data insertion sub-system 104 forwards message 190 to the carrier messaging service center 168 of the message receiver's telecommunications carrier via data communication network(s) 164 and communication links 166, 170. Then, the carrier messaging service center 168 communicates the message 190 to the message receiving device 176 of the message receiver via telecommunication carrier communication network(s) 172 and communication links 174, 178. After forwarding message 190, operation of method 250 loops back to step 258 described above.

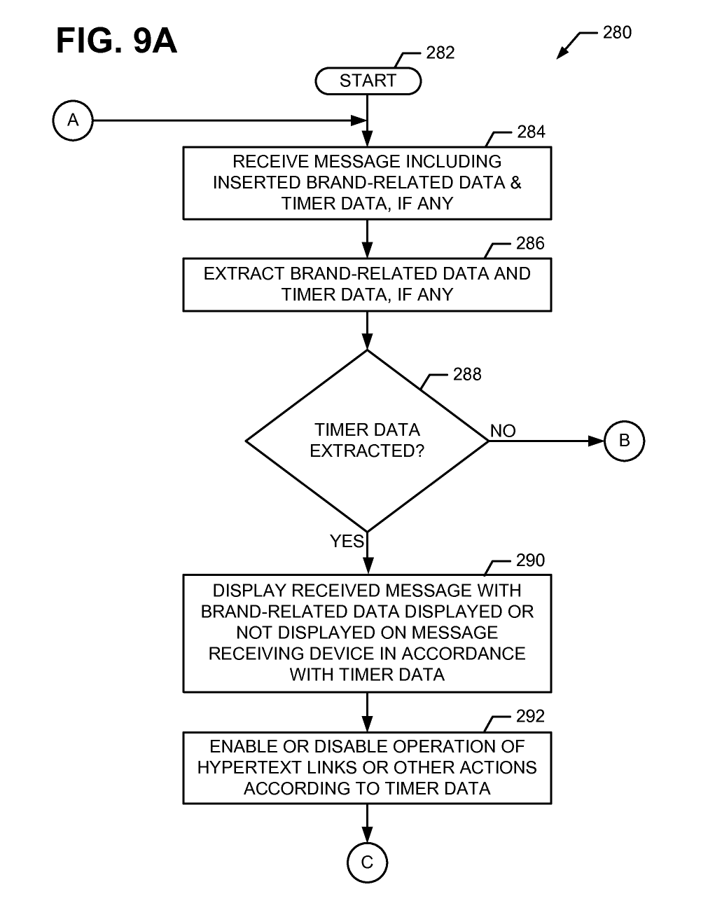

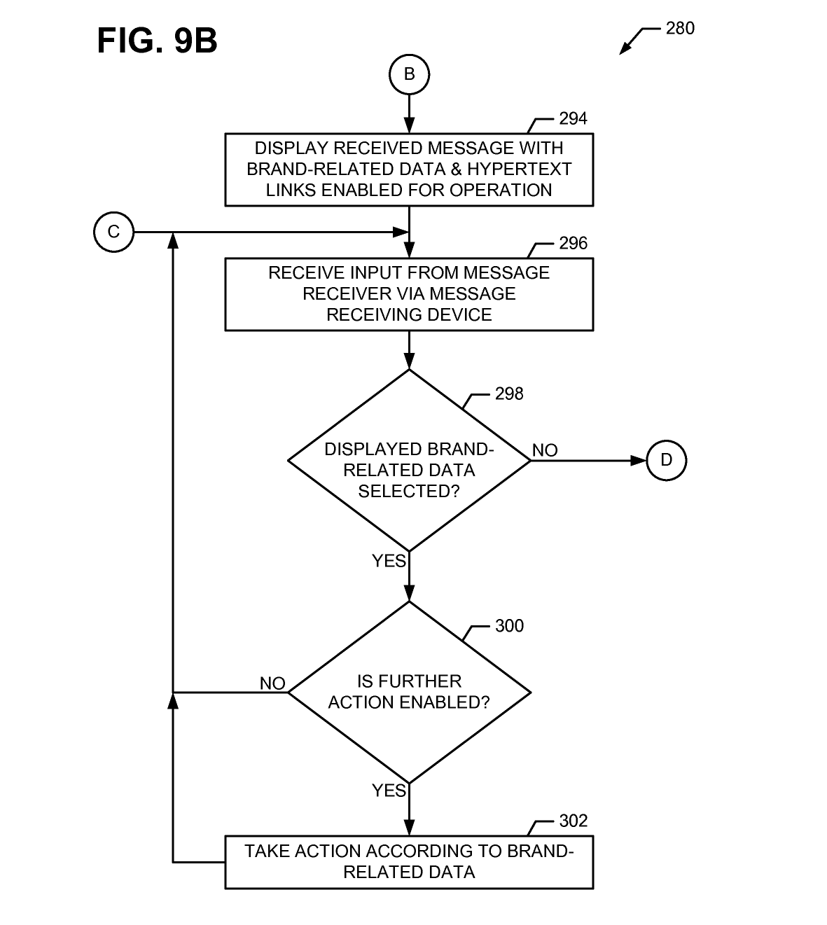

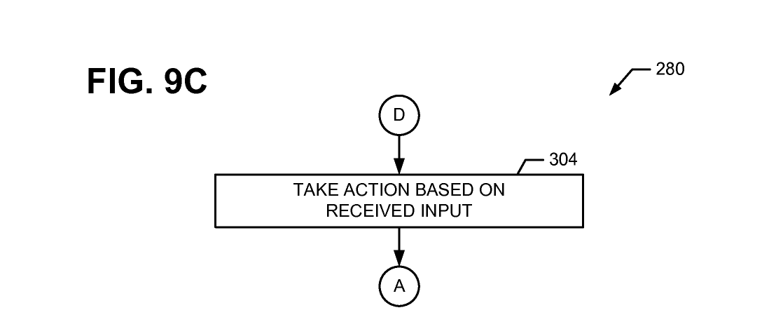

FIGS. 9A-9C display a flowchart representation of a method 280 of the brand-related data insertion and response system 100 for receiving and displaying messages 200 including brand-related data 138 (and, possibly, timer data) on a message receiving device 176 and for taking further action based on the selection of brand-related data 138 via the message receiving device 176. According to the first example embodiment, the method 280 is implemented by receiving device software 106 present on a message receiving device 176 of a message receiver and is executed by a processing unit thereof. It is presumed that messages 190 not including inserted brand-related data 138 are directed to other software of the message receiving device 176 for display thereof. However, it should be understood and appreciated that in other example embodiments, one or more steps of the method 280 may be implemented by other software or programming present on and executed by the same or other devices. It should also be understood and appreciated that additional steps may be employed prior to (such as, without limitation, identifying and directing messages 190 not including brand-related data 138 to other software for handling thereof), after, or in connection with (such as, but not limited to, displaying messages 190 not including brand-related data 138) the steps of method 280 as needed or appropriate for a particular application or implementation of method 280 in order to provide the functionality described herein.

After starting operation according to method 280 at step 282, a message 200 including embedded brand-related data 138 and, possibly, timer data is received by the message receiving device 176 at step 284. Then, at step 286, the receiving device software 106 causes the message receiving device 176 to extract the embedded brand-related data 138 and timer data, if any, from the message 200. Proceeding to step 288 of method 280, the message receiving device 176 determines whether any timer data was extracted from the received message 200. If no timer data was extracted, operation of the message receiving device 176 branches to step 294 of method 280 described below. If timer data was extracted, operation of the message receiving device 176 continues at step 290 where the message receiving device 176 displays the text and/or images of the received message 200 (see FIG. 1) with the included brand-related data 138 displayed or not displayed, depending on the timer data. As described above, the timer data may direct that the brand-related data 138 be displayed always, not displayed after the passage of a period of time or passage of a calendar date specified in the timer data, or not displayed until the passage of a period of time or passage of a calendar date specified in the timer data.

Continuing at step 292 of method 280 and based on the timer data, the message receiving device 176 enables or disables the operation of a hypertext link or taking of other actions specified in the brand-related data 138. Similar to its control over the display of brand-related data 138, the timer data may direct that actions specified in the brand-related data 138 be enabled or disabled always, disabled after the passage of a period of time or passage of a calendar date specified in the timer data, or not enabled until the passage of a period of time or passage of a calendar date specified in the timer data. For example, if the brand-related data 138 includes a hypertext link to Worldwide Web resource accessible via the Internet and the timer data specifies that the link is enabled at all times, the message receiving device 176 may cause a web browser to open on the message receiving device 176 with the hypertext link of the brand-related data 138 being used by the web browser to link to and display an identified webpage when the brand-related data 138 is selected via the message receiving device 176. If, alternatively, the timer data directs that an action specified in the brand-related data 138 be disabled after the passage of a certain period of time (for example and not limitation, one month), the message receiving device 176 will take such action each time the brand-related data 138 is selected via the message receiving device 176 until passage of the period of time as measured from the creation or sending date of the received message 200. After passage of the period of time, the message receiving device 176 will not take such action when the brand-related data 138 is selected. With further actions appropriately enabled or disabled, operation according to method 280 branches ahead to step 296 described below.

Referring back to step 288, if the message receiving device 176 determines that no timer data was extracted from the received message 200, the message receiving device 176 branches to step 294 of method 280. At step 294, the message receiving device 176 displays the received message 200 (including the text and/or images thereof) (see FIG. 1) and displays the brand-related data 138 of the message 200. Any hypertext links and other actions are enabled for use and operation.

Next, at step 296 of method 280, the message receiving device 176 receives input from the message receiver. Advancing to step 298, the message receiving device 176 determines if the input corresponds to the selection of displayed brand-related data 138. If not, the message receiving device 176 branches forward to step 304 described below. However, if the input corresponds to displayed brand-related data 138, the message receiving device 176 decides, at step 300, if further actions have been enabled for the selected brand-related data 138. If further actions have not been enabled, the message receiving device 176 takes no further action and returns to step 296 to receive further input from the message receiver. Alternatively, if further actions for the selected brand-related data 138 have been enabled, the message receiving device 176 takes action in accordance with the action specified in brand-related data 138 at step 302. Such action, for example, may include initiating operation of a web browser or document viewer on the message receiving device 176 and linking to a Worldwide Web resource accessible via a web server 186′ to display a webpage or document. As has been described above, a variety of other actions are possible. After such action has been taken, operation according to method 280 continues with the message receiving device 176 looping back to step 296 where input is received from the message receiver.

If, at step 298, the message receiving device 176 determines that the received input does not correspond to the selection of displayed brand-related data 138, then the message receiver has selected a button or other graphical user interface control that is unrelated to the brand-related data 138. Upon making such determination, the message receiving device 176 moves forward to step 304 and performs the action associated with the button or other graphical user interface control. After performing such action, operation according to method 280 continues at step 284 where the message receiving device 176 receives another message 200.

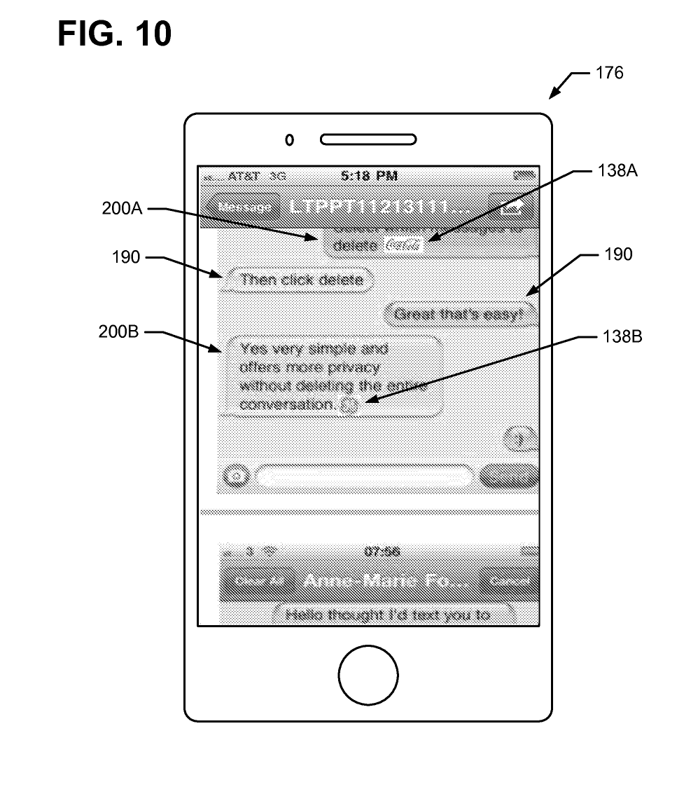

FIG. 10 displays a pictorial representation of a message receiving device 176 displaying messages 200 including brand-related data 138 that has been inserted by the data insertion sub-system 104 of the brand-related data insertion and response system 100. As illustrated in FIG. 10, the message receiving device 176 displays a first message 200A including brand-related data 138A comprising a logo of The CocaCola Company and a second message 200B including brand-related data 138B comprising a logo of General Electric Corporation. The message receiving device 176 also displays a plurality of other messages 190 that do not include brand-related data 138.

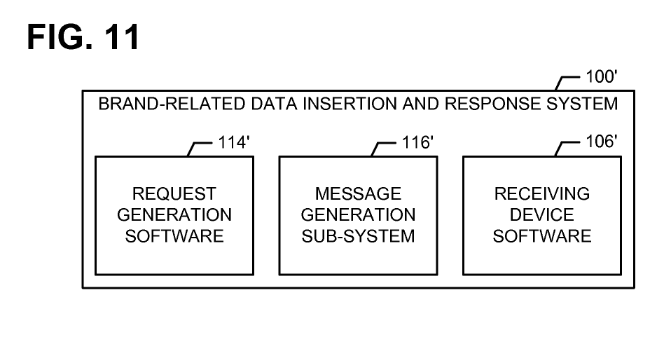

FIG. 11 displays a block diagram representation of a brand-related data insertion and response system 100′ in accordance with a second example embodiment. The brand-related data insertion and response system 100′ of the second example embodiment provides functionality that is substantially similar to that provided by the brand-related data insertion and response system 100 of the first example embodiment. However, the brand-related data insertion and response system 100′ of the second example embodiment shifts the insertion of brand-related data 138′ to the message initiation and management systems 310′ of system users that are configured with request generation software 114′ of the system 100′. Such message initiation and management systems 310′ generally comprise one or more server computer systems equipped with software developed by the system users or third parties that are used by the system users to receive and manage message text and brand-related data 138′, to receive and manage lists of message receivers and their contact information, to generate message requests including brand-related data 138′ through use of the system's request generation software 114′, and to communicate generated message requests to the system's message generation sub-system 116′ for the subsequent generation of messages 200′ for delivery to message receivers.

The brand-related data insertion and response system 100′ of the second example embodiment comprises request generation software 114′, a message generation sub-system 116′, and receiving device software 106′. The request generation software 114′ generally resides on system users' message initiation and management systems 310′ and is executed, during use, by a processing unit thereof. According to the second example embodiment, the request generation software 114′ comprises an application program interface (API), but may comprise other forms of programming or software that provide the functionality described herein in other embodiments.

The request generation software 114′ is adapted to receive a plurality of inputs from other software of a system user's message initiation and management system 310′ and to generate a message request including brand-related data 138′ and other of the inputs for communication to the message generation sub-system 116′ and the subsequent generation of a message 200′ based on such inputs for delivery to a corresponding message receiver. The plurality of inputs includes, for example and not limitation, and is not restricted to: the message receiver's address or identifier (such as a phone number, Internet Protocol (IP) address, or other form of address or identifier) to use for message delivery; the name or identity of message receiver's messaging services provider; the message sender's address or identifier (such as a phone number, Internet Protocol (IP) address, or other form of address or identifier); the name or identity of message sender's messaging services provider; message text; brand-related data 138′ for inclusion in the generated message 200′ including, but not limited to, a Uniform Resource Identifier (URI) for the Worldwide Web resource available from a web server(s) 186′ to be accessed when the message receiver selects, or clicks on, the brand-related data 138′; configuration data 140′ associated with the brand-related data 138′; system user identifier; and, a message sender identifier. The generated message request is configured to cause the message generation sub-system 116′ to produce a message 200′ having a header data 202′ including information enabling delivery of the message 200′ and a data string 204′ including the brand-related data 138′. According to the second example embodiment, the message request is formatted as a Simple Object Access Protocol (SOAP) message that is communicated to the message generation sub-system 116′ via a Hypertext Transfer Protocol (HTTP) post request.

The message generation sub-system 116′ includes computer and telecommunications hardware/software adapted to receive message requests from the message initiation and management systems 310′ of system users, to generate corresponding messages 200′ using the information present in the message requests, and to communicate the messages 200′ to the message receivers identified in the message requests. In accordance with the second example embodiment, the message generation sub-system 310′ may be implemented via and include a combination of a web server, applications server, and other software residing on and executed by one or more server computer systems that may be physically located in the same or different facilities.

The receiving device software 106′ resides on a message receiving device 176′ and is executed by a processing unit thereof. The receiving device software 106′ is substantially similar, if not identical, to the receiving device software 106 of the first example embodiment and is adapted to receive a message 200′ including brand-related data 138′ and, possibly, timer data, to decipher the brand-related data 138′ and timer data, and to take action based on the particular brand-related data 138′ and timer data present as described above with respect to the receiving device software 106 of the first example embodiment. According to the second example embodiment, the receiving device software 106′ comprises an application programming interface (“API”) that is operable with the message receiving device's messaging software. However, in other example embodiments, the receiving device software 106′ may comprise another form of programming executable by the message receiving device 176′ or be included in the message receiving device's messaging software to provide the functionality described herein. Because the receiving devices software 106′ is so similar to the receiving device software 106 of the first example embodiment, no further discussion of its capabilities and functions is included herein.

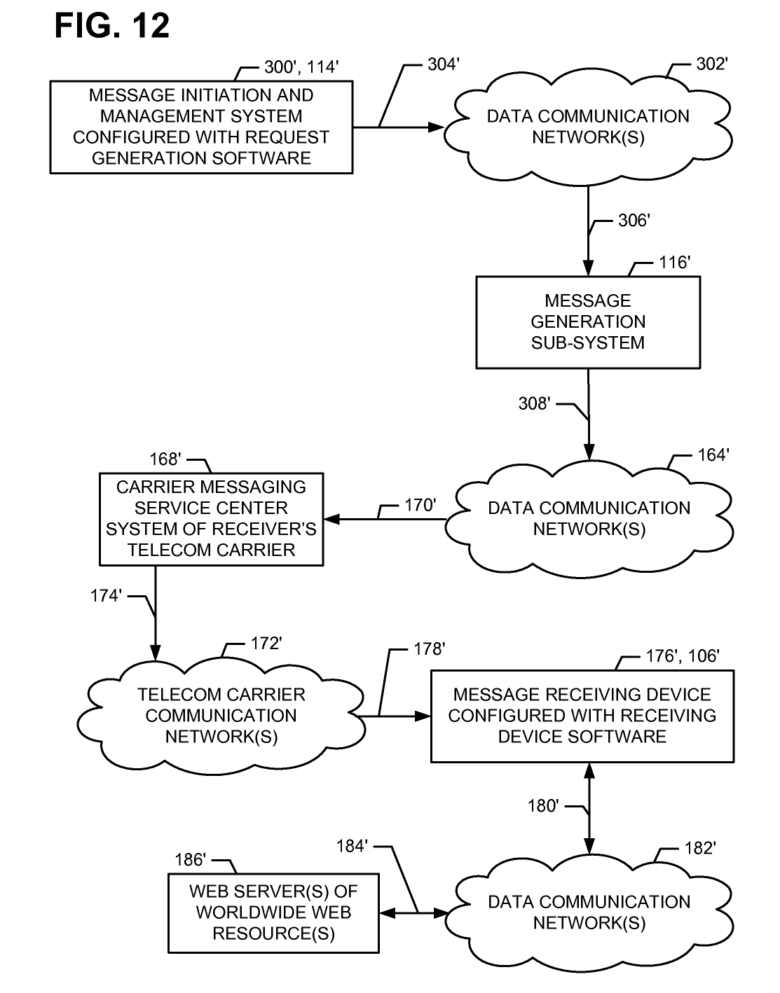

FIG. 12 displays a block diagram representation of the request generation software 114′, message generation sub-system 116′, and the receiving device software 106′ in an environment therefor in which a message 200′ including brand-related data 138′ is generated and communicated to a message receiving device 176′ and is acted upon to access a Worldwide Web resource available via a web server(s) 186′. As shown in FIG. 12, a message initiation and management system 310′ of a system user is connected to the system's message generation sub-system 116′ via data communication network(s) 312′ and communication links 314′, 316′. The message initiation and management system 310′ is configured with request generation software 114′ to produce a message request (as described above) and to communicate such message request to the message generation sub-system 116′ through data communication network(s) 312′ and communication links 314′, 316′.

The message generation sub-system 116′ receives the message request and based on the input data therein, generates a message 200′ including the brand-related data 138′ present in the message request. The message generation sub-system 116′ communicates the message 200′, via data communication network(s) 164′ and communication links 318′, 178′, to the carrier messaging service center system 168′ provided and operated by the telecommunications carrier from which the message receiver receives telecommunications services, including messaging services, on a subscription basis. The message receiver's telecommunications carrier also, typically, provides a telecom carrier communication network 172′ that is communicatively connected by communication link 174′ to carrier messaging service center system 168′. Telecom carrier communication network 172′ is communicatively connected to the message receiving device 176′ of the message receiver via communication link 178′. The message receiving device 176′ comprises any device possessed or used by the message receiver that is configured to receive a message 200′ and to present the message 200′ to the message receiver. The message receiving device 176′ is also configured with the receiving device software 106′, which takes actions (as described herein) based on the brand-related data 138′ present in the message 200′. According to the second example embodiment, the message receiving device 176′ comprises a smartphone capable of sending and receiving messages, but may comprise cell phones, computers, tablet devices, or other devices in other example embodiments.

The message receiving device 176′ is communicatively connected by communication link 182′ to one or more data communication network(s) 182′. Via the data communication network(s) 182′ and a communication link 184′, one or more web server(s) 186′ are communicatively connected to the message receiving device 176′ and permit accessing of or interaction with Worldwide Web resources by the message receiving device 176′, as appropriate and as described above with respect to the first example embodiment, based on the brand-related data 138′ present in the message 200′.

It should be understood and appreciated that the present invention may also be embodied in other forms, including, without limitation, a system 100″ in which proximity sensors (for example, located in a retail store) detect the presence of a message receiving device 176″ of a customer and cause other elements of the system 100″ to generate and send a message 200″ to the message receiving device 176″ including message content together with inserted brand-related data 138″ or to insert brand-related data 138″ in an already communicated message. Upon receiving input from the message receiver via the message receiving device 176″ selecting the brand-related data 138″, the system 100″ may cause the message receiving device 176″ to invoke browser software, access and display a webpage from which, after receiving further input, the message receiving device 176″ may download an electronic coupon usable by the message receiver when purchasing products from and checking out at the retail store.

Whereas the present invention has been described in detail above with respect to example embodiments and configurations thereof, it should be appreciated that variations and modifications might be effected within the spirit and scope of the present invention.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

What is claimed is:

1. A system for managing and processing of a user message as initiated by a sender messaging device of a sending user to an addressed receiver messaging device of a receiving user and transmitted through a telecommunication network to a multimedia messaging system (MMS) implemented therein for transmitting the received user message from the sender messaging device to the receiver messaging device based on a receiver message device address, the system comprising:
a first server having an input interface and an output interface, a processor, a memory and computer executable instructions, the input interface coupled to a system user device and receiving a brand-related data (BRD) message and associated BRD configuration data for the BRD message, the brand-related data message including a unique identification of the system user from among a plurality of system users of the first server, the BRD configuration data including at least one BRD message insertion rule applicable to the received BRD message, the first server assigning a BRD message instance ID to the BRD message and storing the BRD message and the associated BRD configuration data in the memory; and
a second server having a processor, a memory and computer executable instructions, and having a first interface communicatively coupled to the output interface of the first server and at least one second interface communicatively coupled to the telecommunication network and to the multimedia messaging system implemented therein, the second server receiving from the MMS system the received user message as received from the MMS system prior to the MMS system transmitting the user message to the receiver messaging device using the received message device address thereof, the second server receiving the BRD message and associated BRD configuration data from the first server over the first interface and creating a modified user message having the BRD message inserted within the messaging format of the user message with the creating being responsive to the at least one BRD message insertion rule associated with the BRD message, the second server transmitting the modified user message over the second interface to the telecommunication network for delivery of the modified user message to the receiver messaging device.

2. The system of claim 1 wherein the at least one BRD message insertion rule in the BRD configuration data that is applicable to the received BRD message is selected from the group consisting of when the BRD message is to be inserted, the number of times and frequency as to the insertion of the BRD message, one or more message processing circumstances for inserting the BRD message, an identification as to the placement or location of the BRD message relative the user message within the modified user message, an identification of a executable link or file associated with the BRD message, and a timing or a duration of a display or an enabled action associated with the BRD message within the modified user message after receipt by the receiver messaging device of the modified user message.

3. The system of claim 1 wherein the at least one BRD message insertion rule includes an executable link or file identifying a network accessible resource selected from the group consisting of an image, a video, an audio, a document, a material, a program, a webpage, a website, and an Internet/url address.

4. The system of claim 1 wherein the at least one BRD message insertion rule includes instructions for the second server to review the received user message to determine if the received user message includes within a header a pre-authorized by the sender allowing for the modification of the sender initiated user message to include the BRD message, wherein the second server is configured to create the modified user message with the BRD message contained therein only where the received user message included a pre-authorization.

5. The system of claim 1 wherein the brand related data message is selected from the group consisting of data representative of or corresponding to an image, picture, symbol, icon or graphic element used as a brand, trademark, or service mark associated with a company, business, organization, product, or service; a hypertext link, Worldwide Web link, an Internet address to an image, a video, an audio, a document, a material, a program, a webpage, and a website, and an Internet resource.

6. The system of claim 1 wherein the brand related data message is selected from the group consisting of data representative of or corresponding to an image, picture, symbol, icon or graphic element used as a brand, trademark, or service mark associated with a company, business, organization, product, or service, and wherein the second server further creates the modified user message to include a hypertext link, a Worldwide Web link, or an Internet address that can be activated by the receiving user device upon receiving user received input upon displaying of the modified user message on the receiving user device, and wherein the created user data includes instructions within the brand related data for configuring the receiving user device to initiate an action selected from the group consisting of displaying an image, a video, an audio, a document, and a material, and activating an application program on the receiving user device, initiating the opening of a webpage by a browser application on the receiving user device, and accessing a remote website or Internet resource by the receiving user device.

7. The system of claim 1 wherein the at least one BRD message insertion rule includes instructions for the second server to create the modified user message to include the BRD message inserted inline with the user message of the modified user message and the created modified message enables the displaying of the inserted BRD message on the receiving user device inline with the content of the user message.

8. The system of claim 1 wherein the at least one BRD message insertion rule includes instructions for creating the modified user message to include the BRD message to be placed within the modified user message at the beginning or at the end of the content of the user message.

9. The system of claim 1 wherein the BRD message is a graphics element including a brand, a logo, an image, an icon, or a symbol and wherein the second server receives the graphics element from the first server and creates the modified user message to include the inserted graphics element inserted within the messaging format of the user message, the BRD message of the graphics element being a graphics element associated with a company, a client, a product or a service associated with an entity providing the BRD message and associated BRD configuration data to the first server.

10. The system of claim 1, further comprising,
in the multimedia messaging system (MMS), having computer executable instructions for reviewing the received user message to determine if the received user message includes within a header a pre-authorized by the sender allowing for the modification of the sender initiated user message to include the BRD message, wherein the multimedia messaging system only transmits the received user message to the second server when the MMS system identifies that the received user contains a pre-authorization, and wherein the second server only receives the user message when the second server can apply the at least one BRD message insertion rule as provided by the associated BRD configuration data and creating the modified user message to include the BRD message inserted within the messaging format of the user message.

11. The system of claim 1 wherein the at least one BRD message insertion rule applicable to the received BRD message includes a pre-determined interval or frequency of received user messages, a pre-determined number of received user messages, and a random message indicator and wherein the second server is configured to create the modified message to include the BRD message responsive a BRD message insertion rule based thereon.

12. The system of claim 1 wherein the second server is configured to receive a plurality of user messages from the MMS system over the second interface, to determined a message count value for each of the received plurality of user messages and to store the determined message count value, and a predetermined message count threshold value, the at least one BRD message insertion rule applicable to the received BRD message includes a pre-determined message count interval or frequency of received user messages for modifying the user message to include the BRD message, wherein the second server is configured to compare a current count value for a received user message to the stored pre-determined message count value, and to only create a modified user message responsive to the comparing.

13. The system of claim 1 wherein the at least one BRD message insertion rule applicable to the received BRD message inserting the brand-related data further comprises BRD receiving user device timer data associated with the BRD message, wherein the second server creates the modified user message to include the BRD receiving user device timer data in addition to the user message and the BRD message, the BRD receiving user device timer data configured to instruct the receiving user device with instructions and rules as to the timing and duration of the displaying of the BRD message contained within the received modified user message.

14. The system of claim 1 wherein the second server is implemented as a sub-system component of the MMS system.

15. A system for managing and processing of a user messages as initiated by sender messaging devices of a plurality of sending users, each to a at least one of a plurality of addressed receiver messaging devices of a plurality of receiving users, with each user message being transmitted through a telecommunication network to a multimedia messaging system (MMS) implemented therein that transmits the received user messages from each sender messaging device to the addressed receiver messaging devices based on receiver message device addresses, the system comprising:
a first server having an input interface and an output interface, a processor, a memory and computer executable instructions, the input interface coupled to a plurality of system user devices and receiving a plurality of brand-related data (BRD) messages each having associated BRD configuration data, each the brand-related data message including a unique identification of the system user from among the plurality of system users of the first server, each BRD configuration data for each BRD message including at least one BRD message insertion rule applicable to the associated BRD message, the first server assigning a BRD message instance ID to each BRD message and storing each BRD message and the associated BRD configuration data in the memory based thereon; and
a second server having a processor, a memory and computer executable instructions, and having a first interface communicatively coupled to the output interface of the first server and at least one second interface communicatively coupled to the telecommunication network and to the multimedia messaging system implemented therein, the second server receiving from the MMS system one or more of the received user messages as received from the MMS system prior to the MMS system transmitting the one or more user message to the receiver messaging device using the received message device address thereof, the second server receiving each BRD message and the associated BRD configuration data for each BRD message from the first server over the first interface and for each creating a modified user message having at least one BRD message inserted within the messaging format of the user message with the creating being responsive to the at least one BRD message insertion rule associated with the BRD message, the second server transmitting each modified user message over the second interface to the telecommunication network for delivery of the modified user message to the receiver messaging device per the receiver message device address therewith.

16. The system of claim 15 wherein the for each received user message, the second server modifying each user message as a function of each of the one or more BRD message insertion rules of each of the BRD configuration data for each received BRD message, wherein each of the BRD insertion rules is selected from the group consisting of when the BRD message is to be inserted, the number of times and frequency as to the insertion of the BRD message, one or more message processing circumstances for inserting the BRD message, an identification as to the placement or location of the BRD message relative the user message within the modified user message, an identification of a executable link or file associated with the BRD message, and a timing or a duration of a display or an enabled action associated with the BRD message within the modified user message after receipt by the receiver messaging device of the modified user message.

17. The system of claim 15 wherein each BRD message insertion rule in the BRD configuration data that is applicable to the received BRD message is selected from the group consisting of when the BRD message is to be inserted, the number of times and frequency as to the insertion of the BRD message, one or more message processing circumstances for inserting the BRD message, an identification as to the placement or location of the BRD message relative the user message within the modified user message, an identification of a executable link or file associated with the BRD message, and a timing or a duration of a display or an enabled action associated with the BRD message within the modified user message after receipt by the receiver messaging device of the modified user message.

18. The system of claim 15 wherein one or more of the BRD message insertion rules of one or more of the BRD configuration data for one or more BRD messages includes an executable link or file identifying a network accessible resource selected from the group consisting of an image, a video, an audio, a document, a material, a program, a webpage, a website, and an Internet/url address.

19. The system of claim 15 wherein at least one of the BRD message insertion rules for the plurality of BRD configuration data for the plurality of BRD messages includes instruction the second server to review the received user message to determine if the received user message includes within a header a pre-authorized by the sender allowing for the modification of the sender initiated user message to include the BRD message, wherein the second server is configured to create the modified user message with the BRD message contained therein only where the received user message included a pre-authorization.

20. The system of claim 15 wherein the brand related data message is selected from the group consisting of data representative of or corresponding to an image, picture, symbol, icon or graphic element used as a brand, trademark, or service mark associated with a company, business, organization, product, or service; a hypertext link, Worldwide Web link, an Internet address to an image, a video, an audio, a document, a material, a program, a webpage, and a website, and an Internet resource.

21. The system of claim 15 wherein each brand related data message is selected from the group consisting of data representative of or corresponding to an image, picture, symbol, icon or graphic element used as a brand, trademark, or service mark associated with a company, business, organization, product, or service, and wherein the second server further creates the modified user message to include a hypertext link, a Worldwide Web link, or an Internet address that can be activated by the receiving user device upon receiving user received input upon displaying of the modified user message on the receiving user device, and wherein the created user data includes instructions within the brand related data for configuring the receiving user device to initiate an action selected from the group consisting of displaying an image, a video, an audio, a document, and a material, and activating an application program on the receiving user device, initiating the opening of a webpage by a browser application on the receiving user device, and accessing a remote website or Internet resource by the receiving user device.

22. The system of claim 15 wherein at least one of the BRD message insertion rules for one or more of the BRD configuration data includes instructions for the second sever to create the modified user message to include the BRD message inserted inline with the user message of the modified user message and the created modified message enables the displaying of the inserted BRD message on the receiving user device inline with the content of the user message.

23. The system of claim 15 wherein the at least one BRD message insertion rule includes instructions for the second sever to create the modified user message to include the BRD message to be placed within the modified user message at the beginning or at the end of the content of the user message.

24. The system of claim 15 wherein one or more of the BRD messages is a graphics element including a brand, a logo, an image, an icon, or a symbol and wherein the second server receives the graphics element from the first server and creates the modified user message to include the inserted graphics element inserted within the messaging format of the user message, the BRD message of the graphics element being a graphics element associated with a company, a client, a product or a service associated with an entity providing the BRD message and associated BRD configuration data to the first server.

25. The system of claim 15, further comprising,
in the multimedia messaging system (MMS), having computer executable instructions for reviewing the received user message to determine if the received user message includes within a header a pre-authorized by the sender allowing for the modification of the sender initiated user message to include the BRD message, wherein the multimedia messaging system only transmits the received user message to the second server when the MMS system identifies that the received user contains a pre-authorization, and wherein the second server only receives the user messages when the second server applies the at least one BRD message insertion rule as provided by the associated BRD configuration data and creates the modified user message to include one or more BRD message inserted within the messaging format of the user message.

26. The system of claim 15 wherein the at least one BRD message insertion rule applicable to one of the received BRD messages includes a pre-determined interval or frequency of received user messages, a pre-determined number of received user messages, and a random message indicator and wherein the second server is configured to create the modified message to include the BRD message responsive a BRD message insertion rule based thereon.

27. The method of claim 15 wherein at least one BRD message insertion rule for one or more BRD configuration data for one or more BRD messages includes BRD receiving user device timer data associated with the BRD message, wherein the second server creates the modified user message to include the BRD receiving user device timer data in addition to the user message and the BRD message, the BRD receiving user device timer data configured to instruct the receiving user device with instructions and rules as to the timing and duration of the displaying of the BRD message contained within the received modified user message.

28. The system of claim 15 wherein the second server is implemented as a sub-system component of the MMS system.
